(19) United States
(12) Patent Application Publication
(10) Pub. No.: US 2023/0052600 A1
(43) Pub. Date: Feb. 16, 2023

(54) ELECTRIC MACHINES HAVING A RADIALLY EMBEDDED PERMANENT MAGNET ROTOR AND METHODS THEREOF

(71) Applicant: Regal Beloit Australia Pty Ltd, Rowville (AU)

(72) Inventors: Mark Thiele, Cape Woolamai (AU); Greg Heins, Rowville (AU); Dean James Patterson, Murwillumbah (AU)

(21) Appl. No.: 17/403,498

(22) Filed: Aug. 16, 2021

(51) Int. Cl. H02K 1/27; H02K 1/28; H02K 21/16

(52) U.S. Cl. CPC H02K 1/2773; H02K 1/28; H02K 21/16

(57) ABSTRACT

A rotor assembly for use in a radial flux electric motor assembly includes a rotor core having a plurality of rotor poles circumferentially spaced about a central axis, wherein the rotor core includes a first end and an opposing second end. The rotor assembly further includes a plurality of core magnets alternately spaced with the plurality of rotor poles. The plurality of rotor poles define a radial aperture between each pair of circumferentially adjacent rotor poles, and each radial aperture is configured to receive at least one core magnet of the plurality of core magnets therein. A plurality of end magnets are coupled to at least one of the first end and the second end, and at least one end plate coupled to the plurality of end magnets.

### BACKGROUND

The field of the disclosure relates generally to electric motors, and more particularly, to radially embedded permanent magnet rotors and methods of increasing flux density and specific torque.

Radial flux electric machines generally include permanent magnets positioned within a rotor core, commonly referred to as an interior permanent magnet rotor. The rotor is formed from multiple laminations and circumferentially spaced poles. Slots are formed between adjacent poles, and magnets are inserted into the slots. However, in some known radial flux electric machines, Flux may leak across laminations pole and radiate out from the rotor, which may induce eddy currents in nearby conductive structure. The leakage flux, while relatively small, can cause significant eddy current losses which has a detrimental effect on both torque and efficiency of the electric machine during operation.

At least some radial flux electric machines increase the axial length of the rotor, that is, use additional laminations, to overcome the loss of torque resulting from the flux leakage. However, additional laminations undesirably increase the cost and overall size of the electric machine and also increases manufacturing complexity.

Similarly, at least some radial flux electric machines use an over-molding technique to increase the robustness of the rotor structure. However, over-molding requires additional tooling and manufacturing steps that increase the cost of the electric machine.

### BRIEF DESCRIPTION

In one embodiment, a rotor assembly for use in a radial flux electric motor assembly is provided. The rotor assembly includes a rotor core having a plurality of rotor poles circumferentially spaced about a central axis, wherein the rotor core includes a first end and an opposing second end. The rotor assembly further includes a plurality of core magnets alternately spaced with the plurality of rotor poles. The plurality of rotor poles define a radial aperture between each pair of circumferentially adjacent rotor poles, and each radial aperture is configured to receive at least one core magnet of the plurality of core magnets therein. A plurality of end magnets are coupled to at least one of the first end and the second end, and at least one end plate coupled to the plurality of end magnets.

In another embodiment, an electric motor assembly is provided. The electric motor assembly includes a stator assembly having a stator core and a plurality of windings. The motor assembly also includes a rotor assembly having a rotor core with a plurality of rotor poles circumferentially spaced about a central axis, wherein the rotor core includes a first end and an opposing second end. The rotor assembly further includes a plurality of core magnets alternately spaced with the plurality of rotor poles. The plurality of rotor poles define a radial aperture between each pair of circumferentially adjacent rotor poles, and each radial aperture is configured to receive at least one core magnet of the plurality of core magnets therein. A plurality of end magnets of the rotor assembly are coupled to at least one of the first end and the second end, and at least one steel end plate of the rotor assembly is coupled to the plurality of end magnets.

In yet another embodiment, a rotor assembly for use in a radial flux electric motor assembly is provided. The rotor assembly includes a rotor core having a plurality of rotor poles circumferentially spaced about a central axis, wherein the rotor core includes a first end and an opposing second end. The rotor assembly further includes a plurality of core magnets alternately spaced with the plurality of rotor poles. The plurality of rotor poles define a radial aperture between each pair of circumferentially adjacent rotor poles, and each radial aperture is configured to receive at least one core magnet of the plurality of core magnets therein. The rotor assembly also includes at least one steel end plate coupled to the rotor core and the core magnets.

### BRIEF DESCRIPTION OF THE DRAWINGS

FIG. 1 is a perspective cut-away view of an exemplary electric motor assembly;

FIG. 2 is an end view of a stator assembly and a rotor assembly of the electric motor assembly shown in FIG. 1;

FIG. 3 is a perspective view of an exemplary rotor core that may be included within the electric motor assembly shown in FIG. 1;

FIG. 4 is a perspective view of an exemplary rotor assembly that includes the rotor core shown in FIG. 3 and that may be included within the electric motor assembly shown in FIG. 1;

FIG. 5 is a partially exploded view of the rotor assembly shown in FIG. 4;

FIG. 6 is a cross-sectional view of the rotor assembly shown in FIG. 4;

FIG. 7 is a perspective view of a partially assembled rotor assembly shown in FIG. 4; and

FIG. 8 is a cross-sectional view of an alternative rotor assembly that includes the rotor core shown in FIG. 3 and that may be included within the electric motor assembly shown in FIG. 1.

### DETAILED DESCRIPTION

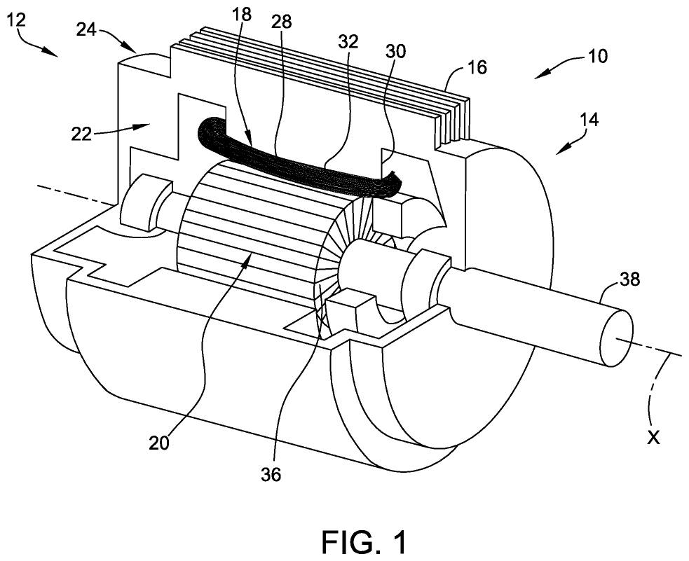

FIG. 1 is a perspective cut-away view of an exemplary electric motor 10. Although referred to herein as electric motor 10, electric motor 10 can be operated as either a generator or a motor. Electric motor 10 includes a first end 12, a second end 14, and a motor assembly housing 16. Electric motor 10 also includes a stator assembly 18 and a rotor assembly 20. Motor assembly housing 16 defines an interior 22 and an exterior 24 of motor 10 and is configured to at least partially enclose and protect stator assembly 18 and rotor assembly 20. Stator assembly includes a stator core 28, which includes a plurality of teeth 30 and a plurality of windings 32 wound around stator teeth 30. Furthermore, in an exemplary embodiment, stator assembly 18 is a three-phase salient pole stator assembly and stator core 28 is formed from a stack of laminations made of highly magnetically permeable material. Alternatively, stator assembly 18 is a single-phase salient pole stator assembly. Stator assembly 18 may be a substantially round, segmented, or roll-up type stator construction and windings 32 are wound on stator core 28 in any suitable manner that enables motor 10 to function as described herein. For example, windings 32 may be concentrated type or overlapped type windings.

Rotor assembly 20 includes a permanent magnet rotor core 36 and a shaft 38. In the exemplary embodiment, rotor core 36 is formed from a stack of laminations made of magnetically permeable material. Rotor core 36 is substantially received in a central bore of stator core 28 for rotation along an axis of rotation X. FIG. 1 illustrates rotor core 36 and stator core 28 as solid for simplicity. While FIG. 1 is an illustration of a three-phase electric motor, the methods and apparatus described herein may be included within motors having any number of phases, including single phase and multiple phase electric motors.

In the exemplary embodiment, electric motor 10 is coupled to a fan or centrifugal blower (not shown) for moving air through an air handling system, for blowing air over cooling or heating coils, and/or for driving a compressor within an air conditioning/refrigeration system. More specifically, motor 10 may be used in air moving applications used in the heating, ventilation, and air conditioning (HVAC) industry, for example, in residential applications using ⅕ horsepower (hp) to 1 hp motors. Alternatively, motor 10 may be used in fluid pumping applications. Motor 10 may also be used in commercial and industrial applications and/or hermetic compressor motors used in air conditioning applications, where motor 10 may have a rating of greater than 1 hp. Although described herein in the context of an air handling system, electric motor 10 may engage any suitable work component and be configured to drive such a work component.

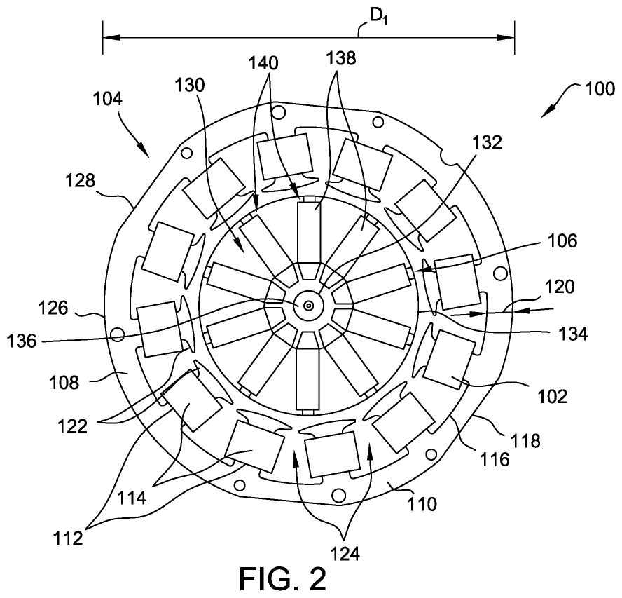

FIG. 2 is a cross-sectional end view of an exemplary electric motor 100 having a central axis 102 and that includes a stator assembly 104 and a rotor assembly 106. Stator assembly 104 includes an annular core 108 having a stator yoke or base 110 and a plurality of stator teeth 112 extending radially inward from base 110. In the exemplary embodiment, a plurality of windings 114 are wound around stator teeth 112 such that each tooth 112 includes a single winding 114. In other embodiments, stator assembly 104 includes one winding 114 for every other tooth 112.

Stator base 110 includes an inner surface 116 and an outer surface 118. Inner surface 116 and outer surface 118 extend about central axis 102 and are spaced radially apart. Inner surface 116 and outer surface 118 define a thickness 120 of base 110 therebetween. In alternative embodiments, stator assembly 104 includes any base 110 that enables motor assembly 100 to operate as described herein.

Also, in the exemplary embodiment, stator assembly 104 has an outer diameter D1 defined by base 110. In some embodiments, the outer diameter D1 is in a range of about 100 mm (4 inches (in.)) to about 350 mm (14 in.). For example, in some embodiments, bas 110 has an outer diameter of approximately 240 mm (9.5 in.) or approximately 310 mm (12.2 in.). In alternative embodiments, stator assembly 104 has any diameter that enables motor assembly 100 to operate as described herein.

In addition, in the exemplary embodiment, stator teeth 112 extend radially from base 110. In some embodiments, stator teeth 112 are integral with base 110. In further embodiments, stator teeth 112 are coupled to base 110. In the exemplary embodiment, each stator tooth 112 includes a distal tip 122 that is positioned proximate rotor assembly 106.

In addition, in the exemplary embodiment, stator teeth 112 are spaced circumferentially about base 110 and define slots 124 therebetween. Stator teeth 112 are configured to receive conduction coils or windings 114 such that windings 114 extend around teeth 112 and through slots 124. In some embodiments, stator teeth 112 define no more than 24 slots. In the exemplary embodiment, stator assembly 104 includes eighteen stator teeth 112 defining eighteen slots 124. In alternative embodiments, motor assembly 100 includes any number of stator teeth 112, such as twelve, that enable motor assembly 100 to operate as described herein.

In some embodiments, stator assembly 104 is assembled from a plurality of laminations. Each of the plurality of laminations is formed in a desired shape and thickness. The laminations are coupled together to form stator assembly 104 having the desired cumulative thickness. In further embodiments, stator assembly 104 includes a first configuration, e.g., a flat or strip configuration, and a second configuration, e.g., a round configuration. Stator assembly 104 is moved or “rolled” from the first configuration to the second configuration to form a roll-up stator assembly 104 having a substantially cylindrical shape. In alternative embodiments, stator assembly 104 is assembled in any manner that enables stator assembly 104 to function as described herein.

Also, in the exemplary embodiment, outer surface 118 includes curved portions 126 and straight portions 128. Curved portions 126 extend circumferentially about base 110. Straight portions 128 extend along chords between curved portions 126. In addition, curved portions 126 and straight portions 128 extend longitudinally relative to central axis 102 from a first end to a second end of base 110. Curved portions 126 provide increased strength to base 110 to increase hoop stress capacity and resist deformation of base 110. In alternative embodiments, outer surface 118 includes any portion that enables motor assembly 100 to operate as described herein. For example, in some embodiments, outer surface 118 is curved about the entire periphery of base 110.

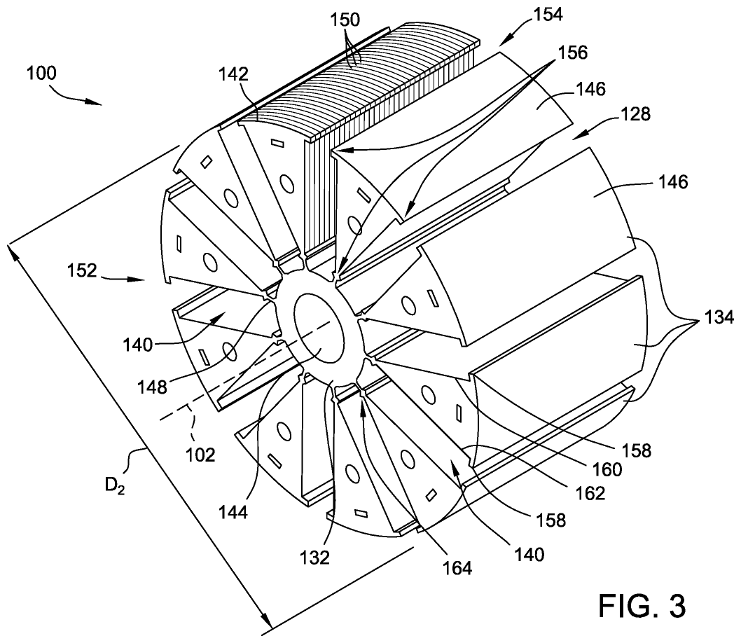

With continued reference to FIG. 3, rotor assembly 106 includes a rotor core 130 having a hub portion 132, and a plurality of rotor poles 134 circumferentially spaced about hub portion 132. Hub portion 132 includes an opening configured to receive a rotatable shaft 136 therethrough that is coupled to a load. In the exemplary embodiment, rotor core 130 also includes a plurality of core magnets 138 alternately spaced with the plurality of rotor poles 134. The plurality of rotor poles 134 define a radial aperture 140 between each pair of circumferentially adjacent rotor poles 134, and each radial aperture 140 is configured to receive at least one core magnet 138 therein.

Accordingly, in the exemplary embodiment, rotor assembly 106 is a spoked rotor and is configured to provide increased magnetic flux in comparison to at least some known rotor assemblies. Stator assembly 104 is configured to provide capacities for the increased magnetic flux and the increased hoop stress due to the increased magnetic flux. In alternative embodiments, motor assembly 100 includes any rotor assembly 106 that enables motor assembly 100 to operate as described herein.

FIG. 3 is a perspective view of rotor core 130 illustrating the plurality of rotor poles 134 that may be included within the radial flux electric motor assembly 100 shown in FIG. 2. In the exemplary embodiment, rotor assembly 106, also referred to as a radially embedded permanent magnet rotor, includes rotor core 130 and shaft 136. Examples of motors that may include the radially embedded permanent magnet rotors include, but are not limited to, electronically commutated motors (ECM's). ECM's may include, but are not limited to, brushless direct current (BLDC) motors, brushless alternating current (BLAC) motors, and variable reluctance motors. Furthermore, rotor assembly 20 is driven by an electronic control (not shown), for example, a sinusoidal or trapezoidal electronic control.

Rotor core 130 is substantially cylindrical and includes an outer periphery 142 and a shaft central opening 144 having a diameter suitable for the diameter of shaft 136. Rotor core 130 and shaft 136 are concentric and are configured to rotate about axis of rotation 102. In the exemplary embodiment, rotor core 130 includes the plurality of circumferentially spaced rotor poles 134 each having an outer wall 146 along rotor outer periphery 142. Further, rotor core 130 includes a rotor diameter D2 defined between midpoints of outer walls 146 of opposing rotor poles 134. As used herein, the term “substantially cylindrical” is meant to describe that the rotor core 130 includes a generally circular or oval cross-section but is not required to be perfectly circular. For example, rotor core 130 may include one or more flattened or planar portions distributed about outer periphery 142, or outer walls 146 of rotor poles 134 may include a different radius than the overall rotor core 130 or even different radii between circumferential ends of each pole 134. Although described in relation to rotor core 130, the term “substantially cylindrical” applies to each rotor core of the disclosure.

As shown in FIG. 3, in the exemplary embodiment, each rotor pole 134 is coupled to hub portion 132 by a web 148. Hub 132 defines shaft opening 144. In other embodiments, less than all of rotor poles 134 may be coupled to hub 132. Furthermore, in the exemplary embodiment, rotor core 130, and therefore each rotor pole 134, is formed by a plurality of stacked laminations 150 that are coupled together by interlocking, adhesive, welding, bolting, or riveting. For example, laminations 150 are fabricated from multiple punched layers of stamped metal such as steel.

Furthermore, in the exemplary embodiment, rotor core 130 includes the plurality of radial apertures 140 alternately spaced with rotor poles 134. Each radial aperture 140 is configured to receive one or more permanent magnets 138 such that each magnet 138 is radially embedded in rotor core 130 and extends at least partially from a rotor first end 152 to a rotor second end 154. In the exemplary embodiment, radial apertures 140 are generally rectangular. Alternatively, radial apertures 140 may have any suitable shape corresponding to the shape of the permanent magnets that enables electric motor to function as described herein. In the exemplary embodiment, permanent magnets 138 are ceramic magnets magnetized in a direction tangent to axis of rotation X. However, magnet 116 may be fabricated from any suitable material that enables motor 10 to function as described herein, for example, bonded neodymium, AlNiCo, sintered neodymium, bonded and ceramic ferrite, and/or samarium cobalt.

In the exemplary embodiment, the number of radial apertures 140 is equal to the number of rotor poles 134, and one magnet 138 is positioned within each radial aperture 140 between a pair of rotor poles 134. Although illustrated as including ten rotor poles 134, rotor core 130 may have any number of poles that allows motor 100 to function as described herein, for example, six, eight or twelve poles.

In the exemplary embodiment, each rotor pole 134 includes one or more permanent magnet retention member or protrusions 156. For example, a first pair of protrusions 158 is located proximate pole outer wall 146 along rotor outer edge 142 and extends into adjacent radial apertures 140 from circumferential end walls 160 and 162. Each protrusion 156 of the first pair of protrusions 158 is configured to facilitate retention of magnet 138 within radial aperture 140 by substantially preventing movement of magnet 138 in a radial direction towards outer edge 142. Further, a second pair of protrusions 164 is located proximate web 148 and extend adjacent radial apertures 140 from circumferential end walls 160 and 162. Each protrusion 156 of the second pair of protrusions 164 is configured to facilitate retention of magnet 138 within radial aperture 140 by substantially preventing movement of magnet 138 in a radial direction towards shaft 136. Alternatively, rotor core 130 may have any number and location of protrusions 156 that enable rotor core 130 to function as described herein.

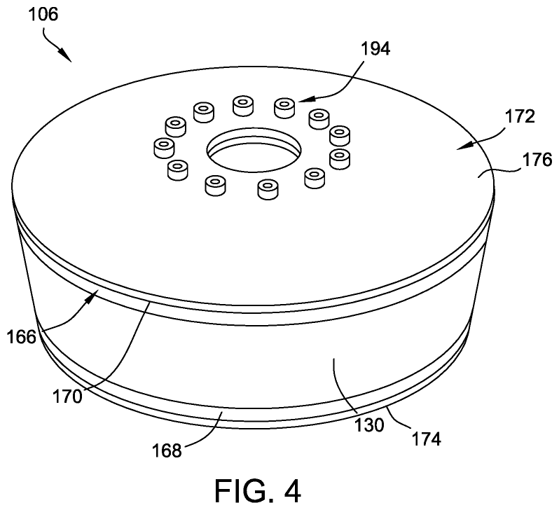

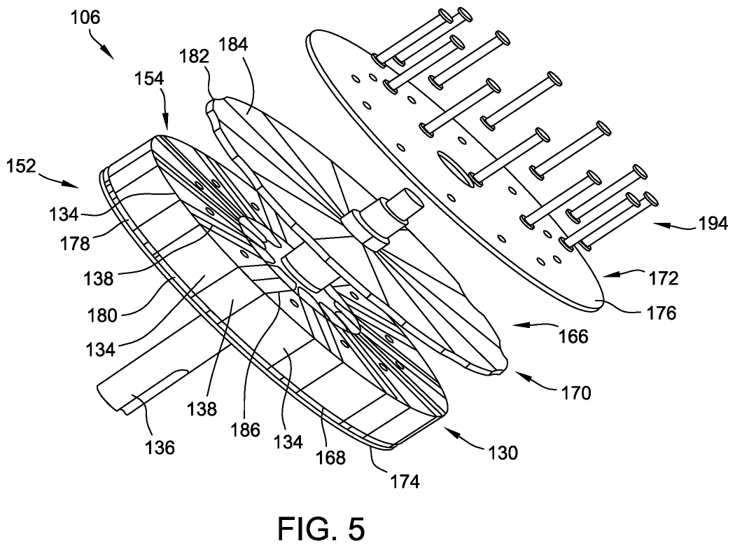

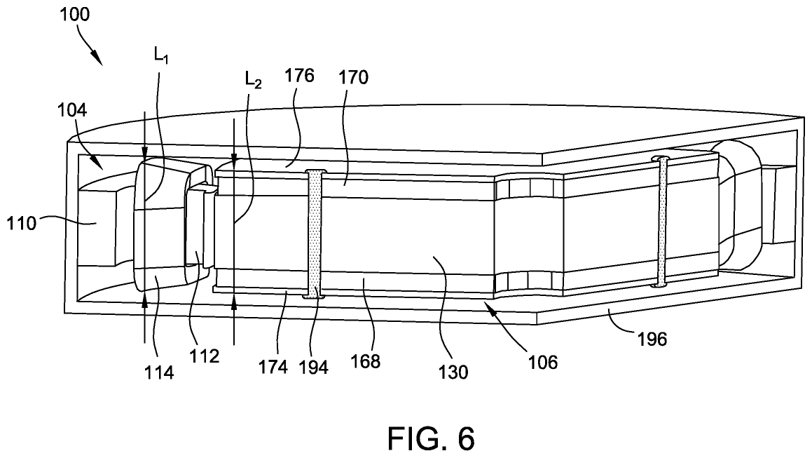

FIG. 4 is a perspective view of rotor assembly 106 that includes the rotor core 130 shown in FIG. 3 and that may be included within the electric motor assembly 100 shown in FIG. 1. FIG. 5 is a partially exploded view of rotor assembly 106, and FIG. 6 is a cross-sectional view of rotor assembly 106. In the exemplary embodiment, rotor assembly 106 includes a plurality of end magnets 166 coupled to at least one of first end 152 of rotor core 130 and second end 154 of rotor core 130. More specifically, rotor assembly 106 includes a first plurality 168 of end magnets 166 coupled to first end 152 of rotor core 130 and a second plurality 170 of end magnets 166 coupled to second end 154 of rotor core 130.

Additionally, in the exemplary embodiment, rotor assembly 106 includes at least one end plate 172 coupled to plurality of end magnets 166. More specifically, rotor assembly 106 includes a first end plate 174 coupled to first plurality 168 of end magnets 166 and a second end plate 176 coupled to second plurality 170 of end magnets 166. Eddy current losses into surrounding conductive structures can be eliminated or reduced by preventing flux leakage from the axial face of radial spoke rotors. End plates 174 and 176 provide a barrier to the flux radiating from rotor core 130 into the surrounding structure of motor assembly 100 and therefore eliminates eddy current losses. In the exemplary embodiment, end plates 174 and 176 are formed from a magnetic material, such as but not limited to ferritic steel and magnetic stainless steel. Alternatively, end plates 174 and 176 are formed from any material that facilitates operation of rotor assembly 106 as described herein. In some embodiments, end plates 174 and 176 may cause flux shorting, which may reduce the overall torque of motor assembly 100. In the exemplary embodiment, end magnets 166 are added to rotor assembly 106 to restore flux, resulting in substantial increases in both torque and efficiency. More specifically, first plurality 168 of end magnets 166 is positioned between first end 152 of rotor core 130 and first end plate 174. Similarly, second plurality 170 of end magnets 166 is positioned between second end 154 of rotor core 130 and second end plate 176.

In the exemplary embodiment, first plurality 168 of end magnets 166 comprises a first subset 178 having a first polarity and a second subset 180 having a second polarity different from the first polarity. Similarly, second plurality 170 of end magnets 166 comprises a first subset 182 having a first polarity and a second subset 184 having a second polarity different from the first polarity. As shown in FIG. 5, first subset 182 is alternately spaced with second subset 184 of end magnets 166.

Regarding the positioning of end magnets 166, in the exemplary embodiment, each end magnet 166 at least partially covers an interface 186 between a rotor pole 134 and an adjacent core magnet 138. More specifically, each end magnet 166 will at least partially overlap with a corresponding rotor pole 134 and core magnet 138 such that end magnets 166 provide a path for flux to flow between rotor pole 134 and core magnet 138. Alternatively, in cases where end magnets 166 may not cover interface 186, a circumferential edge of end magnets 166 is flush with a circumferential edge of the corresponding rotor pole 134. In one embodiment, end magnets 166 are secured to rotor core 130 using an adhesive. Alternatively, end magnets 166 are secured to rotor core 130 in any manner that facilitates operation of rotor assembly as described herein.

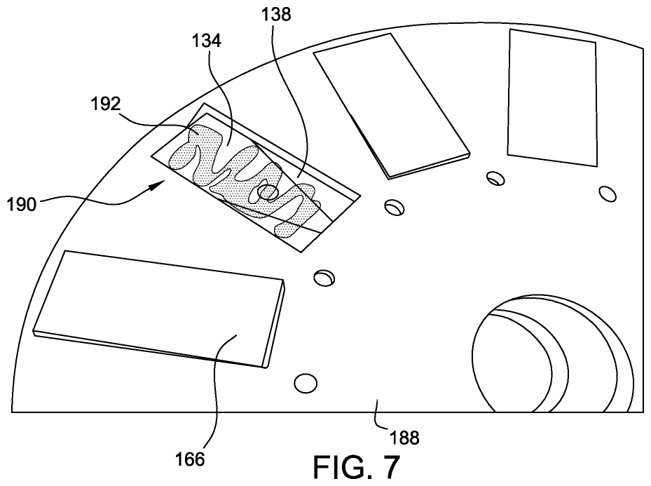

In the exemplary embodiment, as shown in FIG. 5, end magnets 166 of first subset 182 and second subset 184 abut against one another without any structural holder. In another embodiment, shown in FIG. 7, rotor assembly 106 includes a pair of frames 188 coupled to respective ends 152 and 154 of rotor core 130. Frame 188 includes a plurality of circumferentially spaced openings 190 configured to receive the plurality of end magnets 166 therein. In such an embodiment, frame 188 defines a substantially similar diameter as rotor core 130 and is made of a non-magnetic material, such as but not limited to plastic, so as not to interfere with the flow of flux between rotor core and end magnets 166. Frame 188 is attached to rotor poles 134 and core magnets 138 using an adhesive 190 and assures proper positioning of end magnets 166 over interface 186 within rotor assembly 106. As shown in the embodiments of FIGS. 5 and 7, end magnets 166 may be similar in shape to the shape of laminations of rotor cores 134, or end magnets 166 may have a different shape. Generally, end magnets 166 may be any shape that facilitates operation of rotor assembly as described herein.

As shown in FIGS. 4 and 5, rotor assembly 106 is held together using a plurality of fasteners 194, such as but not limited to rivets, screws, or bolts with nuts. Specifically, in the exemplary embodiment, fasteners 194 extend through openings in first end pate 174, first plurality 168 of end magnets 166, rotor poles 134, second plurality of end magnets 170, and second end plate 176. In embodiments, having frame 188, fasteners 194 extend through frame 188 rather than through end magnets 166. Fasteners 194 enables the mechanical locking of the components of rotor assembly 106 without the use of potting material for overmolding. The locations at which fasteners 194 extend are areas of very low flux density, and fasteners 194 are formed from one of aluminum, stainless steel, or ferritic steel. Alternatively, fasteners 194 are formed from any material that facilitates operation of rotor assembly as described herein.

Referring specifically to FIG. 6, adding end magnets 166 and end plates 172 does not significantly add to the axial length of motor assembly 100. Specifically, stator assembly 104 has a maximum axial length L1 at windings 114, and rotor assembly 106 has a maximum axial length L2 at either fasteners 194 or defined between exterior surfaces of opposing end plates 172. In either case, axial lengths L1 and L2 are substantially similar to each other. Also shown in FIG. 6 is the housing 196 that surrounds stator assembly 104 and rotor assembly 106.

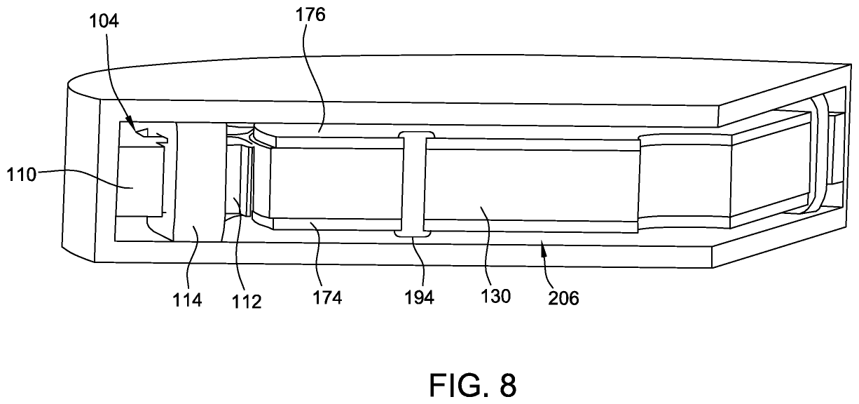

FIG. 8 illustrates an alternative embodiment of a rotor assembly 206 for use in electric motor assembly 100, shown in FIG. 1. Rotor assembly 206 is substantially similar to rotor assembly 106 in operation and composition, with the exception that rotor assembly 206 does not include end magnets 166 of rotor assembly 106. Rather, end plates 174 and 176 are coupled directly to rotor poles 134 and core magnets 138 of rotor core 130. As such, components shown in FIG. 8 are labeled with the same reference numbers used in FIGS. 2-7. As described herein, end plates 174 and 176 provide a barrier to the flux radiating from rotor core 130 into the surrounding structure of motor assembly 100 and therefore eliminates eddy current losses.

Described herein are exemplary systems and apparatus that reduce eddy current loses and to increase the torque and efficiency of an electric motor. The systems and apparatus described herein may be used in any suitable application. However, they are particularly suited for HVAC and pump applications.

Specifically, eddy current losses into surrounding conductive structures can be eliminated or reduced by preventing flux leakage from the axial face of radial spoke rotors. The end plates described herein provide a barrier to the flux radiating from the rotor core into the surrounding structure of the motor assembly and therefore eliminates eddy current losses. Eddy current losses are reduced, for example, from 146 W to 10 W (93% reduction). Adding axial magnets and rotor steel end caps to radial spoked rotors increases efficiency and torque by preventing flux leaking axially which induce eddy currents in surrounding conductive structure. Additionally, the rotor assembly described herein is more simply manufactured compared to other known rotor assemblies due to the use of mechanical fasteners to secure the components of the rotor assembly together. In such an embodiment, tooling and processes used to over-mold the rotor are no longer required, thus leading to reduced manufacturing time and costs.

Exemplary embodiments of rotor cores for electric machines are described above in detail. The electric motor and its components are not limited to the specific embodiments described herein, but rather, components of the systems may be utilized independently and separately from other components described herein. For example, the components may also be used in combination with other motor systems, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rotor assembly for use in a radial flux electric motor assembly, said rotor assembly comprising:
a rotor core comprising a plurality of rotor poles circumferentially spaced about a central axis, wherein said rotor core comprises a first end and an opposing second end;
a plurality of core magnets alternately spaced with said plurality of rotor poles, wherein said plurality of rotor poles define a radial aperture between each pair of circumferentially adjacent rotor poles, and wherein each radial aperture is configured to receive at least one core magnet of said plurality of core magnets therein;
a plurality of end magnets coupled to at least one of said first end and said second end; and
at least one end plate coupled to said plurality of end magnets.

2. The rotor assembly of claim 1, wherein said plurality of end magnets comprises a first plurality of end magnets coupled to said first end and a second plurality of end magnets coupled to said second end.

3. The rotor assembly of claim 2, wherein said first plurality of end magnets comprises a first subset of end magnets having a first polarity and a second subset of end magnets having a second polarity different from the first polarity, and wherein said first subset of end magnets are alternately spaced with said second subset of end magnets.

4. The rotor assembly of claim 2, wherein said at least one end plate comprises a first end plate coupled to said first plurality of end magnets and a second end plate coupled to said second plurality of end magnets.

5. The rotor assembly of claim 1, wherein each end magnet covers an interface between a rotor pole of the plurality of rotor poles and an adjacent core magnet of the plurality of core magnets.

6. The rotor assembly of claim 1, further comprising an adhesive configured to attach said plurality of end magnets to said plurality of rotor poles.

7. The rotor assembly of claim 1, wherein said at least one end plate is comprised of at least one of ferritic steel and magnetic stainless steel.

8. The rotor assembly of claim 1, further comprising a plurality of fasteners extending through said plurality of end magnets, said at least one end plate, and said rotor core.

9. The rotor assembly of claim 1, further comprising a frame coupled to said rotor poles and said core magnets, wherein said frame comprises a plurality of circumferentially spaced openings configured to receive said plurality of end magnets.

10. The rotor assembly of claim 9, wherein said frame is comprised from a non-magnetic material.

11. An electric motor assembly comprising:
a stator assembly comprising a stator core and a plurality of windings; and
a rotor assembly comprising:
a rotor core comprising a plurality of rotor poles circumferentially spaced about a central axis, wherein said rotor core comprises a first end and an opposing second end;
a plurality of core magnets alternately spaced with said plurality of rotor poles, wherein said plurality of rotor poles define a radial aperture between each pair of circumferentially adjacent rotor poles, and wherein each radial aperture is configured to receive at least one core magnet of said plurality of core magnets therein;
a plurality of end magnets coupled to at least one of said first end and said second end; and
at least one steel end plate coupled to said plurality of end magnets.

12. The motor assembly of claim 11, wherein said plurality of end magnets comprises a first plurality of end magnets coupled to said first end and a second plurality of end magnets coupled to said second end.

13. The rotor assembly of claim 12, wherein said first plurality of end magnets comprises a first subset of end magnets having a first polarity and a second subset of end magnets having a second polarity different from the first polarity, and wherein said first subset of end magnets are alternately spaced with said second subset of end magnets.

14. The rotor assembly of claim 12, wherein said at least one end plate comprises a first end plate coupled to said first plurality of end magnets and a second end plate coupled to said second plurality of end magnets.

15. The rotor assembly of claim 11, wherein each end magnet covers an interface between a rotor pole of the plurality of rotor poles and an adjacent core magnet of the plurality of core magnets.

16. The rotor assembly of claim 11, further comprising a housing surrounding said stator assembly and said rotor assembly.

17. The rotor assembly of claim 11, wherein said rotor assembly defines a first axial length, and wherein said windings define a second axial length substantially similar to the first axial length.

18. A rotor assembly for use in a radial flux electric motor assembly, said rotor assembly comprising:
a rotor core comprising a plurality of rotor poles circumferentially spaced about a central axis, wherein said rotor core comprises a first end and an opposing second end;
a plurality of core magnets alternately spaced with said plurality of rotor poles, wherein said plurality of rotor poles define a radial aperture between each pair of circumferentially adjacent rotor poles, and wherein each radial aperture is configured to receive at least one core magnet of said plurality of core magnets therein; and
at least one steel end plate coupled to said rotor poles and said core magnets.

19. The rotor assembly of claim 18, wherein said at least one end plate comprises a first end plate coupled to said first end and a second end plate coupled to said second end.

20. The rotor assembly of claim 19, further comprising a plurality of fasteners extending through said first end plate, said rotor core, and said second end plate.
